(19) United States
(12) Patent Application Publication
(10) Pub. No.: US 2020/0082972 A1
(43) Pub. Date: Mar. 12, 2020

(54) CONTINUOUS COILS CONTAINING A THIN ANODIZED FILM LAYER AND SYSTEMS AND METHODS FOR MAKING THE SAME

(71) Applicant: Novelis Inc., Atlanta, GA (US)

(72) Inventors: Michael Jackson Bull, Brighton, MI (US); Jonathan Ball, Wootton Bridge (GB); Dewei Zhu, Marietta, GA (US); Venkatesh Sundaram, Johns Creek, GA (US); Thomas J. Beck, Marietta, GA (US); Kevin Mark Johnson, Woodstock, GA (US)

(73) Assignee: Novelis Inc., Atlanta, GA (US)

(21) Appl. No.: 16/566,283

(22) Filed: Sep. 10, 2019

Related U.S. Application Data
(60) Provisional application No. 62/729,741, filed on Sep. 11, 2018.
(60) Provisional application No. 62/729,702, filed on Sep. 11, 2018.

(51) Int. Cl. H01F 27/28; C25D 11/02; C25D 11/16; H01F 41/04; C25D 11/08

(52) U.S. Cl. CPC H01F 27/2847; C25D 11/024; C25D 11/08; H01F 41/04; C25D 11/16

(57) ABSTRACT

Described herein are anodized continuous coils containing a thin anodized film layer and systems and methods for making and using the same. The anodized continuous coils include an aluminum alloy continuous coil, wherein a surface of the aluminum alloy continuous coil comprises a thin anodized film layer and a chemical additive layer. The thin anodized film layer can be a dielectric for electronic device applications.

### CROSS-REFERENCE TO RELATED APPLICATIONS

The present application claims priority to and filing benefit of U.S. Provisional Patent Application Ser. No. 62/729,741, filed on Sep. 11, 2018, and U.S. Provisional Patent Application Ser. No. 62/729,702, filed on Sep. 11, 2018, which are incorporated herein by reference in their entireties.

### FIELD

The present disclosure relates to metal working generally and more specifically to anodizing and pretreating continuous coils.

### BACKGROUND

Certain metal products, such as aluminum alloys, can benefit from having an anodized surface. These benefits include durability, color stability, ease of maintenance, aesthetics, health and safety, and low cost. However, it is difficult to continuously anodize aluminum alloy coils having an anodized film that meets flexibility, durability and/or surface characteristics requirements for downstream processing, including joining of aluminum alloy articles produced from aluminum alloy coil products.

### SUMMARY

Covered embodiments of the invention are defined by the claims, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

Described herein are anodized continuous coils and methods for making and using the same. An anodized continuous coil as described herein includes an aluminum alloy continuous coil, where a surface of the aluminum alloy continuous coil comprises a thin anodized film layer and a chemical additive layer. The thin anodized film layer includes a barrier layer that can be up to about 25 nm thick. The thin anodized film layer can also include a filament layer that can be from about 25 nm to about 75 nm thick. Optionally, the thin anodized film layer, including the barrier layer and filament layer, can be less than about 100 nm thick. The chemical additive layer can include, but is not limited to, an adhesion promoter, a coupling agent, a corrosion inhibitor, or a pretreatment. Optionally, the chemical additive layer is up to about 50 nm thick. The aluminum alloy continuous coil can comprise a lxxx series aluminum alloy, a 3xxx series aluminum alloy, a 5xxx series aluminum alloy, a 6xxx series aluminum alloy, or a 7xxx series aluminum alloy.

Also described herein are aluminum alloy products including the anodized continuous coils as described herein. The aluminum alloy products can be automobile body parts, aerospace structural parts, transportation body parts, transportation structural parts, or electronics device housings, among others.

Further described herein are methods of making an anodized continuous coil. The methods of making an anodized continuous coil include providing a metal continuous coil, wherein the metal continuous coil is processed in a metal processing line having a preselected line speed; etching a surface of an aluminum alloy continuous coil with an acidic solution; anodizing the surface of the aluminum alloy continuous coil in an electrolyte to form a thin anodized film layer, wherein anodizing parameters are tailored to the preselected line speed of the metal processing line; and applying a chemical additive to the thin anodized film layer to form a chemical additive layer. The thin anodized film layer can be an aluminum oxide layer. The thin anodized film layer prepared according to the methods can be less than about 100 nm thick and the chemical additive layer can be up to about 50 nm thick. The electrolyte can include phosphoric acid.

The methods of making an anodized continuous coil can further include a step of applying a cleaner to the surface of the aluminum alloy continuous coil prior to the etching step and/or a step of rinsing the thin anodized film layer after the anodizing step.

Also described herein is a system for making an anodized continuous coil including a bipolar cell (e.g., a first graphite counter electrode and a second graphite counter electrode), at least one squeegee roller, at least one electrolyte dispensing nozzle, at least one coated stainless steel roller, and an alternating current source.

Also described herein is a system for making an anodized continuous coil including a contact roll electrode, at least one counter electrode, at least one squeegee roller, at least one electrolyte dispensing nozzle, at least one coated stainless steel roller, and a current source configured to supply an alternating current or a direct current to the contact roll electrode.

Also described herein is an electronic device substrate, including an aluminum alloy continuous coil and a thin anodized film layer, where the thin anodized film layer is configured to provide semiconductive properties to the aluminum alloy continuous coil, and where the thin anodized film layer is positioned on an area of a surface of the aluminum alloy continuous coil. In some examples, the thin anodized film layer comprises a uniform thickness across the area of the surface of the aluminum alloy continuous coil, and, optionally, the uniform thickness is configured to conform to a surface morphology of the aluminum alloy continuous coil. In certain aspects, the uniform thickness across the area of the surface of the aluminum alloy continuous coil is devoid of pinholes or pin-spots. In some cases, the thin anodized film layer comprises a uniform dielectric constant across the area of the surface of the aluminum alloy continuous coil, and the thin anodized film layer comprises a breakdown voltage (e.g., at least about ±10 volts) across the area of the surface of the aluminum alloy continuous coil. In other aspects, the thin anodized film layer comprises a leakage current (e.g., up to about ±100 nanoAmperes) across the area of the surface of the aluminum alloy continuous coil. In some examples, the thin anodized film layer is stable up to a frequency of about 100 megaHertz. In certain aspects, the aluminum alloy continuous coil comprises a conductive layer and the thin anodized film layer comprises a dielectric layer. In some non-limiting examples, the electronic device substrate comprises a substrate for an energy storage device, a substrate for an energy harvesting device, a substrate for an energy consuming device, or a substrate for a circuit component.

Other objects, aspects, and advantages will become apparent upon consideration of the following detailed description of non-limiting examples.

### BRIEF DESCRIPTION OF THE FIGURES

FIG. 1A is a schematic of a bipolar cell employed to perform methods described herein.

FIG. 1B is a schematic of a contact roll electrode employed to perform methods described herein.

FIG. 2 is a graph of minimum welding current for resistance spot welding trials performed on exemplary alloys as described herein.

FIG. 3 shows digital images of exemplary aluminum alloys produced, formed, and welded according to methods described herein.

FIG. 4 is a digital image of an exemplary aluminum alloy produced, formed, welded and deformed according to methods described herein.

FIG. 5 is a micrograph of an exemplary aluminum alloy produced and welded according to methods described herein.

FIG. 6 is a micrograph of an exemplary aluminum alloy produced and welded according to methods described herein.

FIG. 7 is a micrograph of an exemplary aluminum alloy produced according to methods described herein.

### DETAILED DESCRIPTION

Described herein are continuous coils having a thin anodized film-containing surface and methods of making and using the continuous coils. The resulting continuous coils can be used, for example, to produce anodized aluminum alloy products that have superior surface qualities and minimized surface defects as compared to aluminum alloy products prepared from coils without a thin-anodized film-containing surface as described herein.

The continuous coils as described herein have a particularly robust and durable surface when exposed, for example, to downstream deforming procedures (e.g., elongation, forming, bending, hot forming, or the like). In addition, continuous coils prepared according to the methods described herein exhibit exceptional adhesion promotion and corrosion resistance. The resulting surfaces are also readily coated by painting, zinc phosphating, electrocoating, lacquering, or laminating. Further, the continuous coils described herein have surface characteristics that make the resulting product amenable to resistance spot welding.

Further, the continuous coils as described herein are composed of a conductive layer (e.g., a metal alloy, for example, the aluminum alloy continuous coil) and a dielectric layer (e.g., the thin anodized film on the aluminum alloy continuous coil), making the continuous coils amenable to layer-by-layer electronic device applications. For example, the continuous coils described herein can be used as electronic device substrates.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference is made to alloys identified by aluminum industry designations, such as “series” or “6xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

Aluminum alloys are described herein in terms of their elemental composition in weight percentage (wt. %) based on the total weight of the alloy. In certain examples of each alloy, the remainder is aluminum, with a maximum wt. % of 0.15% for the sum of the impurities.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a twin block caster, or any other continuous caster), electromagnetic casting, hot top casting, or any other casting method.

As used herein, a “continuous coil” or an “aluminum alloy continuous coil” refers to an aluminum alloy subjected to a continuous processing method on a continuous line without breaks in time or sequence (i.e., the aluminum alloy is not subjected to batch processing).

Reference is made in this application to alloy condition or temper. For an understanding of the alloy temper descriptions most commonly used, see “American National Standards (ANSI) H35 on Alloy and Temper Designation Systems.” An F condition or temper refers to an aluminum alloy as fabricated. An O condition or temper refers to an aluminum alloy after annealing. A T1 condition or temper refers to an aluminum alloy cooled from hot working and naturally aged (e.g., at room temperature). A T2 condition or temper refers to an aluminum alloy cooled from hot working, cold worked, and naturally aged. A T3 condition or temper refers to an aluminum alloy solution heat treated, cold worked, and naturally aged. A T4 condition or temper refers to an aluminum alloy solution heat treated and naturally aged. A T5 condition or temper refers to an aluminum alloy cooled from hot working and artificially aged (at elevated temperatures). A T6 condition or temper refers to an aluminum alloy solution heat treated and artificially aged. A T7 condition or temper refers to an aluminum alloy solution heat treated and artificially overaged. A T8x condition or temper refers to an aluminum alloy solution heat treated, cold worked, and artificially aged. A T9 condition or temper refers to an aluminum alloy solution heat treated, artificially aged, and cold worked.

As used herein, the meaning of “a,” “an,” or “the” includes singular and plural references unless the context clearly dictates otherwise. As used herein, the meaning of “room temperature” can include a temperature of from about 15° C. to about 30° C., for example about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., or about 30° C.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10.

### Anodized Continuous Coils

Described herein are continuous coils having a thin anodized film-containing surface, which are referred to herein as anodized continuous coils. The surface of the continuous coils includes a thin anodized film layer, which includes a barrier layer and optionally a filament layer, and an optional chemical additive layer. The thin anodized films can be applied to a continuous coil of any suitable aluminum alloy. Suitable alloys include, for example, lxxx series aluminum alloys, 3xxx series aluminum alloys, 5xxx series aluminum alloys, 6xxx series aluminum alloys, and 7xxx series aluminum alloys.

By way of non-limiting example, exemplary AA1xxx alloys for use as the aluminum alloy product can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199. In some cases, the aluminum alloy is at least 99.9% pure aluminum (e.g., at least 99.91%, at least 99.92%, at least 99.93%, at least 99.94%, at least 99.95%, at least 99.96%, at least 99.97%, at least 99.98%, or at least 99.99% pure aluminum).

Non-limiting exemplary AA3xxx series alloys for use as the aluminum alloy product can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary AA5xxx series alloys for use as the aluminum alloy product can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary AA6xxx series alloys for use as the aluminum alloy product can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary AA7xxx series alloys for use as the aluminum alloy product can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149, AA7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

In certain aspects, the continuous coil can be prepared from a high purity aluminum alloy (e.g., at least about 99.9 wt. % aluminum as described above) doped with copper (Cu). For example, the aluminum alloy can include up to about 0.01 wt. % Cu (e.g., from about 0.0001 wt. % to about 0.009 wt. %, from about 0.0005 wt. % to about 0.008 wt. %, from about 0.001 wt. %

to about 0.007 wt. %, from about 0.001 wt. % to about 0.01 wt. %, or from about 0.005 wt. % to about 0.01 wt. %).

While aluminum alloy articles are described throughout the text, the methods and articles apply to any metal. In some examples, the metal article is aluminum, an aluminum alloy, magnesium, a magnesium-based material, titanium, a titanium-based material, copper, a copper-based material, steel, a steel-based material, bronze, a bronze-based material, brass, a brass-based material, a composite, a sheet used in composites, or any other suitable metal or combination of materials. The article may include monolithic materials, as well as non-monolithic materials such as roll-bonded materials, clad materials, composite materials, or various other materials. In some examples, the metal article is a metal coil, a metal strip, a metal plate, a metal sheet, a metal billet, a metal ingot, or the like.

The continuous coil can be prepared from an alloy of any suitable temper. In certain examples, the alloys can be used in F, O, T3, T4, T6, or T8 tempers. The alloys can be produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

As described above, the surface of the continuous coil contains a thin anodized film layer. The anodized film layer includes a barrier layer and, optionally, a filament layer. In some cases, the anodized film layer includes a barrier layer only. The barrier layer is composed of aluminum oxide (e.g., nonporous aluminum oxide). The barrier layer can be up to about 25 nm in thickness. In some cases, the barrier layer can be from about 1 nm to about 25 nm, from about 5 nm to about 25 nm, from about 10 nm to about 20 nm, or from about 12 nm to about 17 nm in thickness. For example, the barrier layer can be about 1 nm, about 2 nm, about 3 nm, about 4 nm, about 5 nm, about 6 nm, about 7 nm, about 8 nm, about 9 nm, about 10 nm, about 11 nm, about 12 nm, about 13 nm, about 14 nm, about 15 nm, about 16 nm, about 17 nm, about 18 nm, about 19 nm, about 20 nm, about 21 nm, about 22 nm, about 23 nm, about 24 nm, or about 25 nm in thickness.

The filament layer is optionally present in the thin anodized film layer. Similar to the barrier layer, the filament layer is composed of aluminum oxide (e.g., nonporous aluminum oxide). The filament layer can be up to about 75 nm in thickness. In some cases, the filament layer can be from about 5 nm to about 75 nm, from about 10 nm to about 65 nm, from about 25 nm to about 60 nm, or from about 45 nm to about 55 nm in thickness. For example, the filament layer can be about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, or about 75 nm in thickness.

The thin anodized film layer, including the barrier layer or the barrier layer and the filament layer, can range from about 1 nm to about 100 nm in thickness. In some cases, the thin anodized film layer is less than about 100 nm in thickness (e.g., less than about 90 nm, less than about 80 nm, less than about 70 nm, less than about 60 nm, less than about 50 nm, less than about 40 nm, less than about 30 nm, less than about 20 nm, or less than about 10 nm). For example, the thin anodized film layer can be from about 5 nm to about 100 nm, from about 10 nm to about 90 nm, from about 20 nm to about 80 nm, or from about 30 nm to about 70 nm in thickness. In some examples, the thin anodized film layer can be about 1 nm, 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, or about 95 nm in thickness.

Optionally, the surface of the continuous coil described herein also includes a chemical additive layer that is adhered to the thin anodized film layer. The chemical additive layer can include, for example, a surface property modifying agent such as an adhesion promoter, a coupling agent, a corrosion inhibitor, or a pretreatment. Suitable adhesion promoters include, for example, silanes and polyacrylic acid, among others. Suitable pretreatments include, for example, silicon-based compounds, zirconium-containing compounds (e.g., Ti/Zr compounds and Zr/Cr compounds), titanium-containing compounds, chromium-containing compounds, cerium-containing compounds, vanadium-containing compounds, and manganese-containing compounds, among others. The thickness of the chemical additive layer can be up to about 50 nm. For example, the thickness of the chemical additive layer can be from about 1 nm to about 50 nm, from about 5 nm to about 45 nm, from about 10 nm to about 40 nm, from about 15 nm to about 35 nm, or from about 20 nm to about 30 nm. In some cases, the chemical additive layer can have a thickness of about 1 nm, about 5 nm, about 10 nm, about 15 nm, about 20 nm, about 25 nm, about 30 nm, about 35 nm, about 40 nm, about 45 nm, or about 50 nm.

### Systems for Preparing an Anodized Continuous Coil

Described herein are systems of making an anodized continuous coil. In some non-limiting examples, the systems are configured to form a thin anodized film layer on at least a first surface of the continuous coil. The first surface of the continuous coil can be a top surface, a bottom surface, or a side surface of a continuous coil prepared in a horizontal processing line. In some cases, the first surface can be a front surface, a rear surface, or a side surface of a continuous coil prepared in a vertical processing line. In some aspects, the systems described herein are configured to form the thin anodized film layer on a first side of the continuous coil and a second side of the continuous coil. For example, the thin anodized film layer can be formed on the top surface and the bottom surface of the continuous coil (e.g., in the horizontal processing line), and/or on the front surface and the rear surface of the continuous coil (e.g., in the vertical processing line). In further examples, the thin anodized film layer can be formed on the entirety of the continuous coil (e.g., any exposed surface of the continuous coil).

The systems described herein include a bipolar electrolytic cell (i.e., a bipolar cell). In some cases, a bipolar cell can be employed in a continuous coil processing line to form the thin anodized film layer in situ. In some non-limiting examples, a plurality of bipolar cells can be employed in a continuous coil processing line. Employing a plurality of bipolar cells in the continuous coil processing line provides a customizable thin anodized film forming system. In some examples, the bipolar cell can be used to electrolytically clean the continuous coil. In some cases, the plurality of bipolar cells can be used to clean the continuous coil and form the thin anodized film on the continuous coil. Additionally, the bipolar cell can be used to customize the filament layer and/or the barrier layer. As described herein, a plurality of bipolar cells employed in a continuous coil processing line can be dynamically configured to clean and modify the surface of the continuous coil.

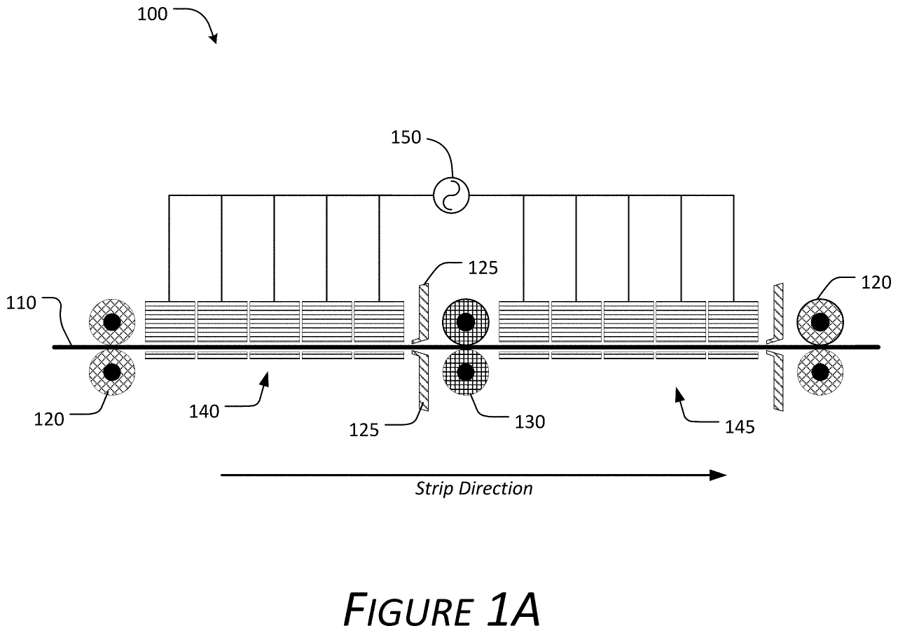

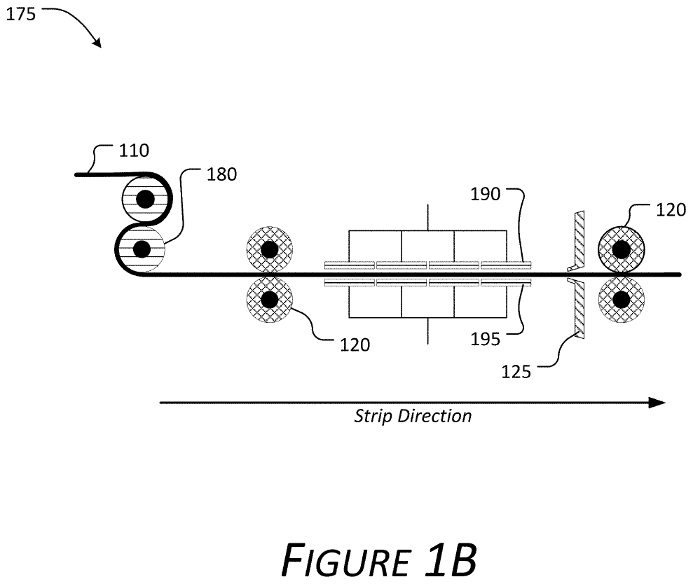

FIG. 1A is a schematic of a bipolar cell 100 employed to perform methods described herein. An aluminum alloy continuous coil 110 is fed into the bipolar cell 100 by squeegee rollers 120 positioned at an entrance to the bipolar cell 100. The squeegee rollers 120 can remove any residual acid remaining from a preparatory etching step. The electrolyte for the anodization process is supplied to the aluminum alloy continuous coil 110 surface by nozzles 125 disposed above a first side of the aluminum alloy continuous coil 110 and below a second side of the aluminum alloy continuous coil 110. Coated stainless steel rollers 130 positioned at a midpoint (or other suitable position) in the bipolar cell 100 stabilize the aluminum alloy continuous coil 110 and continue feeding the aluminum alloy continuous coil 110 through the bipolar cell 100. The bipolar cell 100, including a first graphite counter electrode 140 and a second graphite counter electrode 145 that are powered by an alternating current (AC) source 150, supplies current to pass through the electrolyte and anodize the aluminum alloy continuous coil 110 surface. Squeegee rollers 120 positioned at an exit of the bipolar cell 100 can remove residual electrolyte and continue feeding the aluminum alloy continuous coil 110 out of the bipolar cell 100.

In some non-limiting examples, as illustrated in FIG. 1B, a contact roll can be used as an electrode to form a circuit to perform the methods described herein in a contact roll system 175. An aluminum alloy continuous coil 110 is fed to a contact roll electrode 180. The electrolyte for the anodization process is supplied to the aluminum alloy continuous coil 110 surface by nozzles 125 disposed above a first side of the aluminum alloy continuous coil 110 and below a second side of the aluminum alloy continuous coil 110. In a first configuration, the contact roll electrode 180 and a first counter electrode 190 are configured to form a circuit, and are powered by a current source configured to supply an alternating current (AC) to pass through the electrolyte and anodize the aluminum alloy continuous coil 110 surface. In a second configuration, the contact roll electrode 180 is an anode and the current source is configured to supply a direct current (DC) to pass through the electrolyte and anodize the aluminum alloy continuous coil 110 surface. Squeegee rollers 120 positioned downstream of the contact roll electrode 180 to remove any residual cleaners and/or etchants from the preparatory etching step and continue feeding the aluminum alloy continuous coil 110, and squeegee rollers 120 are positioned downstream of the first counter electrode 190 to remove residual electrolyte and continue feeding the aluminum alloy continuous coil 110 to any further downstream processing.

In some aspects, a plurality of bipolar cells 100 can be used in a single processing line. For example, the plurality of bipolar cells 100 can be used to apply variable power to the electrolyte in a power ramp-up process described below. In some cases, the plurality of bipolar cells 100 can be used to tailor the anodization process as desired.

### Methods of Preparing an Anodized Continuous Coil

Described herein are methods of making an anodized continuous coil. Anodizing a continuous coil as described herein includes anodizing a metal product after processing techniques used to provide the metal product in the form of a continuous coil, including, for example, casting (as described above), homogenizing, hot rolling, warm rolling, cold rolling, solution heat treating, annealing, aging (including natural aging and/or artificial aging), any suitable processing techniques, and/or any combination thereof. Accordingly, anodizing can be performed as a step subsequent to the processing techniques described above to provide the continuous coils. For example, the systems described above can be positioned downstream of a cold rolling mill, an annealing furnace, a continuous annealing and solution heat treating (CASH) line, or any suitable final processing equipment (i.e., the systems described above can replace a metal coiler, or can be positioned between a penultimate metal processing equipment and a metal coiler). Thus, the metal can be processed into a metal product and can be anodized immediately after processing without coiling the metal product (e.g., to provide the continuous coil). Accordingly, when the systems described above are placed in service in a metal processing line, parameters of the systems can depend on a line speed of the metal processing line, for example, line speeds selected and/or dictated by processes including the homogenization, the solution heat treating, and/or the annealing (i.e., temporally-dependent thermal processes). Thus, system parameters including applied power, electrolyte concentration, electrolyte temperature, and/or dwell time, among others, can be tailored according to the predetermined/selected line speed of the metal processing line.

In some cases, the continuous coils described herein can be anodized after coiling. The continuous coils can be stored (e.g., to naturally age the continuous coils) or artificially aged before anodizing. Thus, the continuous coils (e.g., the stored continuous coils or the artificially aged continuous coils) can be uncoiled and fed into the systems described above for anodizing.

A continuous coil pretreatment process as described herein includes cleaning a surface of a continuous coil, performing a preparatory etching step to the surface of the continuous coil with an acidic solution, anodizing the surface of the continuous coil to form a thin anodized film layer on the surface of the continuous coil, rinsing the thin anodized film layer, and applying an optional chemical additive to the thin anodized film layer. The process described herein may be employed in a continuous coil process with continuous coils spliced or joined together. Line speeds for the continuous coil process are variable and can be in the range of about 1 meter per minute (mpm) to about 350 mpm. For example, the line speed can be about 1 mpm, about 2 mpm, about 3 mpm, about 4 mpm, about 5 mpm, about 6 mpm, about 7 mpm, about 8 mpm, about 9 mpm, about 10 mpm, about 15 mpm, about 20 mpm, about 25 mpm, about 30 mpm, about 35 mpm, about 40 mpm, about 45 mpm, about 50 mpm, about 55 mpm, about 60 mpm, about 65 mpm, about 70 mpm, about 75 mpm, about 80 mpm, about 85 mpm, about 90 mpm, about 95 mpm, about 100 mpm, about 105 mpm, about 110 mpm, about 115 mpm, about 120 mpm, about 125 mpm, about 130 mpm, about 135 mpm, about 140 mpm, about 145 mpm, about 150 mpm, about 155 mpm, about 160 mpm, about 165 mpm, about 170 mpm, about 175 mpm, about 180 mpm, about 185 mpm, about 190 mpm, about 195 mpm, about 200 mpm, about 205 mpm, about 210 mpm, about 215 mpm, about 220 mpm, about 225 mpm, about 230 mpm, about 235 mpm, about 240 mpm, about 245 mpm, about 250 mpm, about 255 mpm, about 260 mpm, about 265 mpm, about 270 mpm, about 275 mpm, about 280 mpm, about 285 mpm, about 290 mpm, about 295 mpm, about 300 mpm, about 305 mpm, about 310 mpm, about 315 mpm, about 320 mpm, about 325 mpm, about 330 mpm, about 335 mpm, about 340 mpm, about 345 mpm, or about 350 mpm.

### Cleaning

The pretreatment process described herein includes a step of cleaning one or more surfaces of a continuous coil. The cleaning step removes residual oils, or loosely adhering oxides, from the continuous coil surface. Optionally, the entry cleaning can be performed using a solvent (e.g., an aqueous or organic solvent). Optionally, one or more additives can be added to the solvent. In some aspects, the entry cleaning can be performed using an acid (e.g., an acid electrolyte, described in detail below). In some non-limiting examples, the entry cleaner can be sprayed onto one or more surfaces of the continuous coil. In some aspects, the cleaning step can be performed by spraying water and/or a cleaning solution onto one or more surfaces of the continuous coil at a pressure of from about 2 bar to about 4 bar. For example, the surfaces of the continuous coil can be sprayed at a pressure of about 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, or anywhere in between. Additionally, the entry cleaner can be heated prior to application to one or more surfaces of the continuous coil. In some non-limiting examples, the entry cleaner can be heated to a temperature of from about 85° C. to about 100° C. For example, the entry cleaner can be heated to a temperature of about 85° C., 86° C., 87° C., 88° C., 89° C., 90° C., 91° C., 92° C., 93° C., 94° C., 95° C., 96° C., 97° C., 98° C., 99° C., 100° C., or anywhere in between.

### Preparatory Etching and/or Anodizing

The method described herein also includes performing a preparatory etching step on one or more surfaces of the continuous coil. In some non-limiting examples, the preparatory etching step includes removing any oils, and/or loosely adhering surface oxides (e.g., aluminum oxide). The surface of the continuous coil can be subjected to the preparatory etching step using an acid etch (i.e., an etching procedure that includes an acidic solution). In some cases, the acid etch is a continuation of the cleaning step (e.g., the acid used in the cleaning step can further etch the one or more surfaces of the continuous coil), though it need not be. The acid etch can prepare the surface of the continuous coil for subsequent anodization. Exemplary electrolytes (acids and/or acid electrolytes) for performing the acid etch include ammonium pentaborate, boric acid, citric acid, ammonium adipate, ammonium phosphate monobasic, sulfuric acid, hydrofluoric acid, nitric acid, phosphoric acid, phosphonic acid, and combinations of these. In some cases, the acids for performing the cleaning and the preparatory etching can be used as an electrolyte (i.e., an acid electrolyte) in an anodizing step. For example, the continuous coil passes through an active zone (e.g., an area having an energized electric field) of one or more bipolar cells employed to energize the acid electrolyte and, in some cases, anodize the surface of the continuous coil, described in detail below.

In some cases, the preparatory etching step can be performed as a light etching, an etching only (i.e., without anodizing), or an etching followed by anodizing. The light etching is accomplished by spraying the surface of the continuous coil one or more times (e.g., up to two times, such as once or twice) with an acid electrolyte solution. During the light etching, the one or more bipolar cells remain deactivated such that the surface of the continuous coil is lightly etched and not anodized. Additionally, deionized (DI) water can be sprayed onto the surface of the continuous coil to protect the surface of the continuous coil from drips or stains as it passes through the active zone of the one or more bipolar cells.

In some cases, the etching only includes acid etching or electrochemical etching. As used herein, “etching only” refers to an etching step wherein the acid electrolyte is applied to the surface of the continuous coil and the bipolar cell is activated without any anodizing. Activating the bipolar cell such that no anodizing is performed results in a rapid cleaning and/or etching step. For example, the surface of the continuous coil can be cleaned and/or etched at a rate that is at least 25% faster than standard wet chemistry based cleaning and etching that does not employ a bipolar cell. For example, the cleaning and/or etching time can be at least 30% faster, at least 40% faster, at least 50% faster, at least 60% faster, at least 70% faster, at least 80% faster, or at least 90% faster than cleaning and/or etching performed without a bipolar cell. In some aspects, the etching only step includes preparing the surface of the continuous coil for subsequent processing steps. For example, after the etching only step, the surface of the continuous coil can be coated with a pretreatment solution (e.g., an adhesion promoter, a corrosion inhibitor, a coupling agent, any suitable pretreatment solution, or any combination thereof).

In some non-limiting examples, the etching can be followed by anodizing step. The etching and anodizing combination is performed to provide a thin anodized film surface. In some cases, the thin anodized film surface is a final product. In certain examples, the thin anodized film surface is a substrate for subsequent coatings (e.g., one or more of the pretreatments including an adhesion promoter, a corrosion inhibitor, a coupling agent, any suitable pretreatment solution, or any combination thereof). The anodizing is accomplished by contacting the continuous coil surface with an electrolyte, passing the continuous coil through the active zone of the one or more bipolar cells (as in the example of FIG. 1A, described in detail below), and flowing an electric current through the electrolyte, thereby creating an electrical circuit. Suitable electrolytes include, for example, aqueous solutions containing inorganic acids such as phosphoric acid, nitric acid, sulfuric acid, phosphonic acid, or combinations of these. Other exemplary electrolytes include aqueous solutions of sodium nitrate, sodium chloride, potassium nitrate, magnesium chloride, sodium acetate, copper sulfate, potassium chloride, magnesium nitrate, potassium nitrate, calcium chloride, lithium chloride, sodium carbonate, potassium carbonate, calcium carbonate, sodium bicarbonate, ammonium acetate, silver nitrate, ferric chloride, ammonium pentaborate, boric acid, citric acid, ammonium adipate, ammonium phosphate monobasic, or any combination thereof, among others. In some non-limiting examples, the aqueous electrolyte solution can include from about 1 wt. % to about 30 wt. % of the electrolyte (e.g., from about 5 wt. % to about 25 wt. % or from about 10 wt. % to about 20 wt. %) with the remainder water. For example, the aqueous electrolyte solution can include about 1%, about 2%, about 3%, about 4%, about 5%, about 6%, about 7%, about 8%, about 9%, about 10%, about 11%, about 12%, about 13%, about 14%, about 15%, about 16%, about 17%, about 18%, about 19%, about 20%, about 21%, about 22%, about 23%, about 24%, about 25%, about 26%, about 27%, about 28%, about 29%, about 30%, or anywhere in between.

In some examples, as illustrated in FIG. 1B, a contact roll can be employed as a contact roll electrode 180 to form an electric circuit with the aluminum alloy continuous coil 110. A first counter electrode 190 can be disposed parallel to a first surface of the aluminum alloy continuous coil 110 and a second counter electrode 195 can be disposed parallel to a second surface of the aluminum alloy continuous coil 110. The second surface of the aluminum alloy continuous coil 110 can be opposite the first surface of the aluminum alloy continuous coil 110. Power can be applied to the contact roll electrode 180 and/or the first counter electrode 190 and the second counter electrode 195, thus forming a direct current (DC) circuit or an alternating current (AC) circuit. Applying power to the first counter electrode 190 and the second counter electrode 195 can ensure anodization occurs at an interface between the electrolyte and the surface of the aluminum alloy continuous coil 110. In some examples, when DC power is applied to the first counter electrode 190 and the second counter electrode 195, the first counter electrode 190 and the second counter electrode 195 can be any suitable electrode material. The DC power applied to the first counter electrode 190 can range from about ±5 Volts DC (VDC) to about ±30 VDC (e.g., from about ±6 VDC to about ±25 VDC, from about ±7 VDC to about 20 VDC, or from about ±8 VDC to about ±15 VDC). For example, the DC power applied to the first counter electrode 190 can be about ±5 VDC, about ±6 VDC, about ±7 VDC, about ±8 VDC, about ±9 VDC, about ±10 VDC, about ±11 VDC, about ±12 VDC, about ±13 VDC, about ±14 VDC, about ±15 VDC, about ±16 VDC, about ±17 VDC, about ±18 VDC, about ±19 VDC, about ±20 VDC, about ±21 VDC, about ±22 VDC, about ±23 VDC, about ±24 VDC, about ±25 VDC, about ±26 VDC, about ±27 VDC, about ±28 VDC, about ±29 VDC, or about ±30 VDC.

In certain cases, the DC power can be ramped up to from about ±5 VDC to about ±30 VDC at a rate of from 1 Volt per minute (V/min) to about 15 V/m (e.g., from about 2.5 V/min to about 12/5 V/min, from about 5 V/min to about 10 V/min, or from about 2.5 V/min to about 15 V/min). In certain aspects, ramping can be performed by passing the aluminum alloy continuous coil 110 through the plurality of the bipolar cell 100 described above. For example, the aluminum alloy continuous coil 110 can pass through a first bipolar cell 100 configured to apply a first DC power level, then optionally pass through a second bipolar cell 100 configured to apply a second DC power level. Thus, the aluminum alloy continuous coil 110 can be exposed to an increasing DC power level subjecting the aluminum alloy continuous coil 110 to a power ramp-up process. For example, the ramp rate can be about 1 V/min, about 1.1 V/min, about 1.2 V/min, about 1.3 V/min, about 1.4 V/min, about 1.5 V/min, about 1.6 V/min, about 1.7 V/min, about 1.8 V/min, about 1.9 V/min, about 2 V/min, about 2.1 V/min, about 2.2 V/min, about 2.3 V/min, about 2.4 V/min, about 2.5 V/min, about 2.6 V/min, about 2.7 V/min, about 2.8 V/min, about 2.9 V/min, about 3 V/min, about 3.1 V/min, about 3.2 V/min, about 3.3 V/min, about 3.4 V/min, about 3.5 V/min, about 3.6 V/min, about 3.7 V/min, about 3.8 V/min, about 3.9 V/min, about 4 V/min, about 4.1 V/min, about 4.2 V/min, about 4.3 V/min, about 4.4 V/min, about 4.5 V/min, about 4.6 V/min, about 4.7 V/min, about 4.8 V/min, about 4.9 V/min, about 5 V/min, about 5.1 V/min, about 5.2 V/min, about 5.3 V/min, about 5.4 V/min, about 5.5 V/min, about 5.6 V/min, about 5.7 V/min, about 5.8 V/min, about 5.9 V/min, about 6 V/min, about 6.1 V/min, about 6.2 V/min, about 6.3 V/min, about 6.4 V/min, about 6.5 V/min, about 6.6 V/min, about 6.7 V/min, about 6.8 V/min, about 6.9 V/min, about 7 V/min, about 7.1 V/min, about 7.2 V/min, about 7.3 V/min, about 7.4 V/min, about 7.5 V/min, about 7.6 V/min, about 7.7 V/min, about 7.8 V/min, about 7.9 V/min, about 8 V/min, about 8.1 V/min, about 8.2 V/min, about 8.3 V/min, about 8.4 V/min, about 8.5 V/min, about 8.6 V/min, about 8.7 V/min, about 8.8 V/min, about 8.9 V/min, about 9 V/min, about 9.1 V/min, about 9.2 V/min, about 9.3 V/min, about 9.4 V/min, about 9.5 V/min, about 9.6 V/min, about 9.7 V/min, about 9.8 V/min, about 9.9 V/min, about 10 V/min, about 10.1 V/min, about 10.2 V/min, about 10.3 V/min, about 10.4 V/min, about 10.5 V/min, about 10.6 V/min, about 10.7 V/min, about 10.8 V/min, about 10.9 V/min, about 11 V/min, about 11.1 V/min, about 11.2 V/min, about 11.3 V/min, about 11.4 V/min, about 11.5 V/min, about 11.6 V/min, about 11.7 V/min, about 11.8 V/min, about 11.9 V/min, about 12 V/min, about 12.1 V/min, about 12.2 V/min, about 12.3 V/min, about 12.4 V/min, about 12.5 V/min, about 12.6 V/min, about 12.7 V/min, about 12.8 V/min, about 12.9 V/min, about 13 V/min, about 13.1 V/min, about 13.2 V/min, about 13.3 V/min, about 13.4 V/min, about 13.5

V/min, about 13.6 V/min, about 13.7 V/min, about 13.8 V/min, about 13.9 V/min, about 14 V/min, about 14.1 V/min, about 14.2 V/min, about 14.3 V/min, about 14.4 V/min, about 14.5 V/min, about 14.6 V/min, about 14.7 V/min, about 14.8 V/min, about 14.9 V/min, or about 15 V/min.

Additionally, after ramping, the continuous coils can be anodized by dwelling the continuous coils in the energized electrolyte bath for a dwell time of from about 1 minute to about 30 minutes (e.g., from about 2 min to about 28 min, from about 3 min to about 26 min, from about 4 min to about 25 min, from about 5 min to about 22.5 min, from about 6 min to about 20 min, from about 7 min to about 17.5 min, or from about 8 min to about 15 min). For example, the continuous coils can have a dwell time in the energized electrolyte bath for about 1 min, about 1.5 min, about 2 min, about 2.5 min, about 3 min, about 3.5 min, about 4 min, about 4.5 min, about 5 min, about 5.5 min, about 6 min, about 6.5 min, about 7 min, about 7.5 min, about 8 min, about 8.5 min, about 9 min, about 9.5 min, about 10 min, about 10.5 min, about 11 min, about 11.5 min, about 12 min, about 12.5 min, about 13 min, about 13.5 min, about 14 min, about 14.5 min, about 15 min, about 15.5 min, about 16 min, about 16.5 min, about 17 min, about 17.5 min, about 18 min, about 18.5 min, about 19 min, about 19.5 min, about 20 min, about 20.5 min, about 21 min, about 21.5 min, about 22 min, about 22.5 min, about 23 min, about 23.5 min, about 24 min, about 24.5 min, about 25 min, about 25.5 min, about 26 min, about 26.5 min, about 27 min, about 27.5 min, about 28 min, about 28.5 min, about 29 min, about 29.5 min, or about 30 min. In some examples, when AC power is applied to the first counter electrode 190 and the second counter electrode 195, the first counter electrode 190 and/or the second counter electrode 195 can be any suitable electrode material (e.g., graphite). In the example of the aluminum alloy continuous coil 110, current flow in the electrolyte releases oxygen ions that can migrate to the surface of the aluminum alloy continuous coil 110 and combine with aluminum on the surface of the aluminum alloy continuous coil 110, thus forming alumina (Al₂O₃).

The electrolyte solution can be applied by immersing the aluminum alloy continuous coil or a portion of the aluminum alloy continuous coil (e.g., the aluminum alloy continuous coil surface) in an electrolyte bath. The temperature of the electrolyte bath can be from about 20° C. to about 80° C. (e.g., from about 30° C. to about 40° C., from about 20° C. to about 50° C., from about 30° C. to about 60° C., from about 20° C. to about 70° C., or from about 50° C. to about 80° C.). For example, the temperature of the electrolyte bath can be about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., about 75° C., about 76° C., about 77° C., about 78° C., about 79° C., or about 80° C. Optionally, the electrolyte solution can be circulated to ensure a fresh solution is continuously exposed to the aluminum alloy continuous coil surfaces. The concentration of components in the electrolyte solution can be measured according to techniques as known to those of skill in the art, such as by a titration procedure for free and total acid or by inductively coupled plasma (ICP). For example, the aluminum content can be measured by ICP and controlled to be within a certain range. In some examples, the aluminum content is controlled to be less than about 10.0 g/L. For example, the aluminum content can be less than about 9.5 g/L, less than about 9.0 g/L, less than about 8.5 g/L, less than about 8.0 g/L, less than about 7.5 g/L, less than about 7.0 g/L, less than about 6.5 g/L, less than about 6.0 g/L, less than about 5.5 g/L, less than about 5.0 g/L, less than about 4.5 g/L, less than about 4.0 g/L, less than about 3.5 g/L, less than about 3.0 g/L, less than about 2.5 g/L, less than about 2.0 g/L, less than about 1.5 g/L, less than about 1.0 g/L, less than about 0.5 g/L, less than about 0.4 g/L, less than about 0.3 g/L, less than about 0.2 g/L, or less than about 0.1 g/L. In some non-limiting examples, the electrolyte solution can be sprayed onto the aluminum alloy continuous coil surface. In some aspects, the electrolyte solution can be sprayed onto the aluminum alloy continuous coil surface at a pressure of from about 2 bar to about 4 bar. For example, the electrolyte solution can be sprayed onto the aluminum alloy surface at a pressure of about 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, or anywhere in between. Additionally, the electrolyte solution can be heated prior to application onto the aluminum alloy continuous coil surface. In some non-limiting examples, the electrolyte solution can be heated to a temperature of from about 55° C. to about 100° C. (e.g., from about 55° C. to about 90° C., from about 55° C. to about 80° C., from about 55° C. to about 70° C., from about 60° C. to about 100° C., from about 60° C. to about 90° C., from about 60° C. to about 80° C., from about 60° C. to about 70° C., from about 70° C. to about 100° C., from about 70° C. to about 90° C., or from about 70° C. to about 80° C.). For example, the electrolyte solution can be heated to a temperature of about 55° C., 56° C., 57° C.,58° C., 59° C., 60° C., 61° C., 62° C., 63° C., 64° C., 65° C., 66° C., 67° C., 68° C., 69° C., 70° C., 71° C., 72° C., 73° C., 74° C., 75° C., 76° C., 77° C., 78° C., 79° C., 80° C., 81° C., 82° C., 83° C., 84° C., 85° C., 86° C., 87° C., 88° C., 89° C., 90° C., 91° C., 92° C., 93° C., 94° C., 95° C., 96° C., 97° C., 98° C., 99° C., 100° C., or anywhere in between.

As described above, a counter electrode can form a circuit with the contact roll electrode when the system is energized. The counter electrode can be mounted above the aluminum alloy continuous coil surface, below the aluminum alloy continuous coil surface, or above and below the aluminum alloy continuous coil surface, depending on desired anodization. The anodization can be performed for about 0.4 seconds to about 30 minutes, depending on desired thin anodized film layer thickness, to form the barrier layer or the barrier layer and filament layer.

### Rinsing and Drying the Thin Anodized Film Layer

After anodizing, the aluminum alloy continuous coil surface can be rinsed with a solvent to remove any residual electrolyte remaining after anodizing. Suitable solvents include, for example, aqueous solvents (e.g., deionized water), organic solvents, inorganic solvents, pH-specific solvents (e.g., solvents that do not react with the electrolyte), any suitable solvent, or any combination thereof. The rinse can be performed using sprays or by immersion. The solvent can be circulated to remove the residual electrolyte from the aluminum alloy continuous coil surface and to prevent its resettling on the surface. The temperature of the rinse solvent can be any suitable temperature.

Optionally, after the rinsing step, the surface of the aluminum alloy continuous coil can be dried. The drying step removes any rinse water from the surface of the coil. The drying step can be performed using, for example, an air dryer or an infrared dryer or any other suitable dryer. The drying step can be performed for a time period of up to five minutes. For example, the drying step can be performed for 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 60 seconds or more, 65 seconds or more, or 90 seconds or more, two minutes or more, three minutes or more, four minutes or more, or five minutes.

### Applying a Chemical Additive Layer

The process described herein further includes a step of applying an optional chemical additive layer to the thin anodized film layer. The chemical additive layer is applied such that it is in direct contact with the thin anodized film layer. As described above, the chemical additive can be, for example, a surface property-modifying agent such as an adhesion promoter, a coupling agent, a corrosion inhibitor, or a pretreatment.

Application of the chemical additive produces a thin layer of the additive on the thin anodized film layer. The chemical additive layer can be up to about 50 nm in thickness, as described above. The chemical additive can be applied by rolling the anodized continuous coil with a solution containing the chemical additive, by spraying the anodized continuous coil with a solution containing the chemical additive, by immersing the anodized continuous coil in a solution containing the chemical additive, or by electrophoretic application. A curing step or chemical reaction can optionally be performed.

The methods of preparing an anodized continuous coil described herein include various process parameters that must be tailored to provide a desired thin anodized film layer. In certain aspects, for example when the systems described herein are placed into a continuous coil processing line, the various process parameters that must be tailored to provide a desired thin anodized film layer depend on the line speed of the continuous coil processing line as described above. For example, variations in applied power can affect the properties of the thin anodized film layer, including dielectric breakdown, thickness, and uniformity (e.g., higher line speeds can require higher power application). In other examples, line speed can affect thin anodized film layer thickness, uniformity, and defect occurrence. Thus, creating a thin anodized film layer having desired properties can require extensive process parameter selection which are influenced by the predetermined line speed of the continuous process.

The systems and methods described herein provide the ability to provide metal products having a variety of surface characteristics without a need to batch process the metal products. For example, employing the systems and methods described herein to a metal product production line can provide the ability to clean the metal product, anodize the metal product, pretreat the metal product, or any combination thereof. Additionally, the systems and methods described herein can be employed in the production of a variety of metals as described above. In further examples, the systems and methods described herein can be applied to a metal product having any suitable thickness (e.g., any suitable gauge). Further, the systems and methods described herein provide a faster, more efficient, more cost-effective, and a more flexible process (e.g., a process able to provide a metal product or continuous coil having a variety of surface characteristics) for in-situ cleaning, in-situ anodizing, and/or in-situ pretreating the metal products.

### Methods of Using

The continuous coils described herein can be used in forming products, including products for use in, among others, automotive, electronics, and transportation applications, such as commercial vehicle, aircraft, or railway applications. The continuous coils and methods described herein provide products with surface properties desired in various applications. The products described herein can have high strength, high deformability (elongation, stamping, shaping, formability, bendability, or hot formability), high strength and high deformability, and high resistance to corrosion. Employing a thin anodized film as a surface pretreatment for a continuous coil provides a product that is deformable without damaging the pretreatment. For example, certain polymer based pretreatment films can break during the bending operations used to form an aluminum alloy product.

In some further aspects, employing a thin anodized film as a pretreatment provides a pretreated aluminum alloy product that is thermally treatable without damaging the pretreatment. For example, a hot forming procedure can be applied to form an aluminum alloy article. In some examples, the hot forming can include heating the aluminum alloy product to temperatures of about 100° C. to about 500° C. at a heating rate of about 3° C./second to about 90° C./second, deforming the aluminum alloy product to form an aluminum alloy article, optionally repeating the deforming step and cooling the article. Certain pretreatments cannot sustain such temperatures, damaging the properties of any pretreatment film, where the thin anodized film as a pretreatment is able to withstand elevated temperatures without damage to the thin anodized film.

In certain aspects, the products prepared according to the methods described herein can be coated. For example, the products can be Zn-phosphated and electrocoated (E-coated). The continuous coils described herein, containing the thin anodized film layer and chemical additive layer, display an improved adhesion of coatings as compared to continuous coils that do not contain the thin anodized film and chemical additive layers. Additionally, as part of the coating procedure, the coated samples can be baked to dry the E-coat at about 180° C. for about 20 minutes, while maintaining the thin anodized film and chemical additive layers.

In some further aspects, the continuous coils described herein display a high level of adhesion of laminates or lacquer films onto the surface of the continuous coils. Additionally, laminates and lacquers can be cured after application at temperatures of up to about 230° C. The continuous coils described herein, containing the thin anodized film layer and chemical additive layer, are not damaged by elevated temperatures used in certain downstream processing of aluminum alloy products, providing a thermally resistant pretreatment for aluminum alloy products.

In some non-limiting examples, the aluminum alloy products and a second metal and/or alloy or more can be bonded to form a joint of any suitable configuration, including lap, edge, butt, T-butt, hem, T-edge, and the like. Joining can be performed, for example, by resistant spot welding (RSW). For example, a compressive force (e.g., a forging force) and an electric current can be applied to the aluminum alloy product and second metal to be welded. According to one non-limiting example, the aluminum alloy product and the second metal can be positioned between two or more electrodes (e.g., but not limited to, copper, steel, or tungsten electrodes or any electrodes for supplying a desired conductivity). The aluminum alloy product and the second metal can be positioned in any orientation, configuration, or direction between the two or more electrodes.

In some examples, the continuous coils described herein can be used for chassis, cross-member, and intra-chassis components (encompassing, but not limited to, all components between the two C channels in a commercial vehicle chassis) to gain strength, serving as a full or partial replacement of high-strength steels. In certain examples, the alloys can be used in O, F, T4, T6, or T8 tempers. In certain aspects, the alloys and methods can be used to prepare motor vehicle body part products. For example, the disclosed alloys and methods can be used to prepare automobile body parts, such as bumpers, side beams, roof beams, cross beams, pillar reinforcements (e.g., A-pillars, B-pillars, and C-pillars), inner panels, side panels, floor panels, tunnels, structure panels, reinforcement panels, inner hoods, or trunk lid panels. The disclosed aluminum alloys and methods can also be used in aircraft or railway vehicle applications, to prepare, for example, external and internal panels.

The described alloys and methods can also be used to prepare housings for electronic devices, including mobile phones and tablet computers. For example, the alloys can be used to prepare housings for the outer casing of mobile phones (e.g., smart phones) and tablet bottom chassis, with or without anodizing. Exemplary consumer electronic products include mobile phones, audio devices, video devices, cameras, laptop computers, desktop computers, tablet computers, televisions, displays, household appliances, video playback and recording devices, and the like. Exemplary consumer electronic product parts include outer housings (e.g., facades) and inner pieces for the consumer electronic products.

In certain aspects, the described alloys and methods can further be used to prepare electronic device substrates. For example, an electronic device substrate can include a conductive layer (e.g., an aluminum alloy substrate, such as a continuous coil) and a dielectric layer (e.g., a thin anodized film layer) for preparing a layer-by-layer (e.g., sandwich-style) electronic device. In some examples, the thin anodized film layer (also referred to herein as a thin anodized film) is configured to provide semiconductive properties to the aluminum alloy substrate. Semiconductive properties can include a tunable and/or tailorable conductivity of a material. In certain cases, the conductivity of aluminum can be decreased by depositing a thin anodized film on the aluminum alloy substrate. In some examples, the thin anodized film can render the aluminum alloy non-conductive (e.g., an insulator). For example, while the aluminum alloy is inherently conductive, the thin anodized film deposited onto the aluminum alloy substrate, including Al₂O₃, is a non-conductive and/or high-dielectric (i.e., high-k) film. The thin anodized film can be deposited on at least a portion of at least one surface of the aluminum alloy substrate. In some cases, an entire aluminum alloy surface can include the thin anodized film. For example, the thin anodized film can be rationally patterned on the surface of the aluminum alloy substrate to define an electronic device area. In some cases, the aluminum alloy substrate can be cut to provide a device substrate having the thin anodized film. In some examples, the thin anodized film can have any shape suitable for providing an electronic device substrate, or the aluminum alloy substrate can be cut to any suitable shape to provide the electronic device substrate.

In certain aspects, the thin anodized film has a uniform thickness across the aluminum alloy surface. The dielectric properties of thin films (e.g., thin anodized films) can be dependent on the parameters of the thin film. For example, the dielectric properties can be proportional to the surface area of the device and/or the device substrate and inversely proportional to the thin film thickness. Thus, providing a stable and uniform electronic device substrate requires providing a uniform thin anodized film described herein. Additionally, the thin anodized film conforms to the surface morphology (e.g., surface roughness) further providing the uniform thickness across the area of the electronic device and/or the electronic device substrate. In some aspects, the thin anodized film is devoid of pinholes having a diameter of greater than about 20 nm (e.g., the thin anodized film can have pinholes having a diameter of up to about 20 nm, up to about 15 nm, up to about 10 nm, up to about 5 nm, up to about 1 nm, up to about 0.5 nm, up to about 0.25 nm, or up to about 0.1 nm), and/or pin-spots having a thickness of less than about 1 nm. A pinhole is a void in the thin anodized film that can provide a short-circuit in a layer-by-layer device. For example, when the layer-by-layer device includes the aluminum alloy substrate (e.g., a first conductor), the thin anodized film (e.g., a dielectric), and a second conductive layer deposited onto the thin anodized film, a conductive pathway can be provided in the pinhole, thus allowing current to flow freely between the aluminum alloy conductor and the second conductive layer, creating the short circuit. Further, a pin-spot, as used herein, is an area where the thin anodized film has a varied thickness that is less than the thickness of the remainder of the thin anodized film. As described above, the dielectric properties of the thin anodized film are inversely proportional to the thickness. Thus, thinner portions of the thin anodized film can experience dielectric breakdown and/or film damage when an electric field and/or electric current is applied.

In some examples, the thin anodized film layer has a uniform dielectric constant (k) across the area of the aluminum alloy. In certain aspects, the thin anodized film has a breakdown voltage of at least about ±10 volts (V) (e.g., at least about ±11 V, at least about ±12 V, at least about ±13 V, at least about ±14 V, at least about ±15 V, at least about ±16 V, or at least about ±17 V). As described herein, a breakdown voltage is a voltage at which, when applied to an electronic device having the thin anodized film described herein, the dielectric properties of the thin anodized film are overcome by the applied voltage and electric current can flow across the dielectric layer (e.g., the thin anodized film). For example, a capacitor includes two conductive electrodes having a dielectric layer disposed between the electrodes. When a voltage is applied to the capacitor, electrons accumulate on one electrode until the electric field is strong enough to drive the electrons across the dielectric layer, discharging the capacitor. Thus, when a capacitor discharges, dielectric breakdown occurs in the dielectric layer.

In further examples, the thin anodized film is configured to minimize a leakage current in an electronic device. For example, the thin anodized film can have a leakage current of up to about ±100 nanoAmperes (nA) (e.g., up to 90 nA, up to 80 nA, up to 70 nA, up to 60 nA, up to 50 nA, up to 40 nA, up to 30 nA, up to 20 nA, up to 10 nA, up to 1 nA, up to 90 picoAmperes (pA), up to 50 pA, or up to 1 pA). As described herein, a leakage current is an amount of current that can propagate across the dielectric layer (e.g., the thin anodized film) at applied voltages that are less than the breakdown voltage. In some cases, device defects and/or other device irregularities can allow current to leak through the dielectric layer, indicated as a leakage current. The thin anodized films described herein allow a negligible amount of current to leak through the dielectric layer.

In some cases, the thin anodized film is stable under an applied frequency of up to 100 megaHertz (MHz) (e.g., up to 90 MHz, up to 80 MHz, up to 70 MHz, or up to 60 MHz). Thus, high frequency electricity applied to the thin anodized film will not damage the thin anodized film when a device providing using the electronic device substrates described herein are placed in service (e.g., when used as a capacitor in a circuit).

In some non-limiting examples, the electronic device substrate comprises a substrate for an energy storage device, a substrate for an energy harvesting device, a substrate for an energy consuming device, or a substrate for a circuit component. For example, the energy storage device can be a capacitor, a supercapacitor, a battery, and/or a rechargeable battery. In some cases, the energy harvesting device can be a photovoltaic device. Further, the energy consuming device can be a light-emitting diode, an organic light-emitting diode, a memory module, an electro-audio device, and/or an electrochromic device. In further examples, the circuit component can be a diode, a rectifying diode, a resistor, a transistor, a memristor, any suitable circuit component, or any combination thereof.

### Illustrations

Illustration 1 is an anodized continuous coil, comprising: an aluminum alloy continuous coil, wherein a surface of the aluminum alloy continuous coil comprises a thin anodized film layer and a chemical additive layer.

Illustration 2 is the anodized continuous coil of any preceding or subsequent illustration, wherein the thin anodized film layer comprises a barrier layer.

Illustration 3 is the anodized continuous coil of any preceding or subsequent illustration, wherein the barrier layer is up to about 25 nm in thickness.

Illustration 4 is the anodized continuous coil of any preceding or subsequent illustration, wherein the thin anodized film layer further comprises a filament layer.

Illustration 5 is the anodized continuous coil of any preceding or subsequent illustration, wherein the filament layer is from about 25 nm to about 75 nm in thickness.

Illustration 6 is the anodized continuous coil of any preceding or subsequent illustration, wherein the thin anodized film layer is less than about 100 nm in thickness.

Illustration 7 is the anodized continuous coil of any preceding or subsequent illustration, wherein the chemical additive layer comprises an adhesion promoter, a coupling agent, a corrosion inhibitor, or a pretreatment.

Illustration 8 is the anodized continuous coil of any preceding or subsequent illustration, wherein the chemical additive layer is up to about 50 nm in thickness.

Illustration 9 is the anodized continuous coil of any preceding or subsequent illustration, wherein the aluminum alloy continuous coil comprises a lxxx series aluminum alloy, a 3xxx series aluminum alloy, a 5xxx series aluminum alloy, a 6xxx series aluminum alloy, or a 7xxx series aluminum alloy.

Illustration 10 is an aluminum alloy product prepared from the anodized continuous coil according to the method of any preceding or subsequent illustration.

Illustration 11 is the aluminum alloy product of any preceding or subsequent illustration, wherein the aluminum alloy product comprises an electronic device substrate, an automobile body part, an aerospace structural part, a transportation body part, a transportation structural part, or an electronic device housing.

Illustration 12 is a method making an anodized continuous coil, comprising: providing a metal continuous coil, wherein the metal continuous coil is processed in a metal processing line having a preselected line speed; etching a surface of an aluminum alloy continuous coil with an acidic solution; anodizing the surface of the aluminum alloy continuous coil in an electrolyte to form a thin anodized film layer, wherein anodizing parameters are tailored to the preseleted line speed of the metal processing line; and applying a chemical additive to the thin anodized film layer to form a chemical additive layer.

Illustration 13 is the method of any preceding or subsequent illustration, wherein the thin anodized film layer comprises an aluminum oxide layer.

Illustration 14 is the method of any preceding or subsequent illustration, wherein the thin anodized film layer is less than about 100 nm in thickness.

Illustration 15 is the method of any preceding or subsequent illustration, wherein the chemical additive layer is up to about 50 nm in thickness.

Illustration 16 is the method of any preceding or subsequent illustration, wherein the electrolyte comprises phosphoric acid.

Illustration 17 is the method of any preceding or subsequent illustration, further comprising applying a cleaner to the surface of the aluminum alloy continuous coil prior to the etching step.

Illustration 18 is the method of any preceding or subsequent illustration, further comprising rinsing the thin anodized film layer after the anodizing step.

Illustration 19 is the method of any preceding or subsequent illustration, wherein the aluminum alloy continuous coil comprises a lxxx series aluminum alloy, a 3xxx series aluminum alloy, a 5xxx series aluminum alloy, a 6xxx series aluminum alloy, or a 7xxx series aluminum alloy.

Illustration 20 is the method of any preceding or subsequent illustration, wherein the chemical additive layer comprises an adhesion promoter, a coupling agent, a corrosion inhibitor, or a pretreatment.

Illustration 21 is a system for making an anodized continuous coil according to any preceding or subsequent illustration, comprising a bipolar cell, wherein the bipolar cell comprises a first graphite counter electrode and a second graphite counter electrode; an alternating current source, wherein the alternating current source is configured to supply an alternating current to the bipolar cell; at least one squeegee roller, wherein the at least one squeegee roller is configured to remove residual upstream processing liquids from a surface of a continuous coil; at least one electrolyte dispensing nozzle; and at least one coated stainless steel roller, wherein the at least one coated stainless steel roller is configured to guide the continuous coil through the system.

Illustration 22 is a system for making an anodized continuous coil according to any preceding or subsequent illustration, comprising a contact roll electrode; at least one counter electrode; a current source configured to supply a current to the contact roll electrode, wherein the current is a direct current or an alternating current; at least one squeegee roller, wherein the at least one squeegee roller is configured to guide a continuous coil through the system and to remove residual upstream processing liquids from a surface of the continuous coil; and at least one electrolyte dispensing nozzle.

Illustration 23 is an electronic device substrate according to any preceding or subsequent illustration, comprising: an aluminum alloy continuous coil; and a thin anodized film layer, wherein the thin anodized film layer is configured to provide semiconductive properties to the aluminum alloy continuous coil, and wherein the thin anodized film is positioned on an area of a surface of the aluminum alloy continuous coil.

Illustration 24 is the electronic device substrate according to any preceding or subsequent illustration, wherein the thin anodized film layer comprises a uniform thickness across the area of the surface of the aluminum alloy continuous coil.

Illustration 25 is the electronic device substrate according to any preceding or subsequent illustration, wherein the uniform thickness is configured to conform to a surface morphology of the aluminum alloy continuous coil.

Illustration 26 is the electronic device substrate according to any preceding or subsequent illustration, wherein the uniform thickness across the area of the surface of the aluminum alloy continuous coil is devoid of pinholes and pin-spots.

Illustration 27 is the electronic device substrate according to any preceding or subsequent illustration, wherein the thin anodized film layer comprises a uniform dielectric constant across the area of the surface of the aluminum alloy continuous coil.

Illustration 28 is the electronic device substrate according to any preceding or subsequent illustration, wherein the thin anodized film layer comprises a breakdown voltage across the area of the surface of the aluminum alloy continuous coil.

Illustration 29 is the electronic device substrate according to any preceding or subsequent illustration, wherein the breakdown voltage comprises at least about 10 volts.

Illustration 30 is the electronic device substrate according to any preceding or subsequent illustration, wherein the thin anodized film layer comprises a leakage current across the area of the surface of the aluminum alloy continuous coil.

Illustration 31 is the electronic device substrate according to any preceding or subsequent illustration, wherein the leakage current comprises up to about 100 nanoAmperes.

Illustration 32 is the electronic device substrate according to any preceding or subsequent illustration, wherein the thin anodized film layer is stable up to a frequency of about 100 megaHertz.

Illustration 33 is the electronic device substrate according to any preceding or subsequent illustration, wherein the aluminum alloy continuous coil comprises a conductive layer and the thin anodized film layer comprises a dielectric layer.

Illustration 34 is the electronic device substrate according to any preceding or subsequent illustration, wherein the electronic device substrate is a substrate for an energy storage device, a substrate for an energy harvesting device, a substrate for an energy consuming device, or a substrate for a circuit component.

The following examples will serve to further illustrate the present invention without, however, constituting any limitation thereof. On the contrary, it is to be clearly understood that resort may be had to various embodiments, modifications, and equivalents thereof which, after reading the description herein, may suggest themselves to those of ordinary skill in the art without departing from the spirit of the invention.

### EXAMPLES

### Example 1

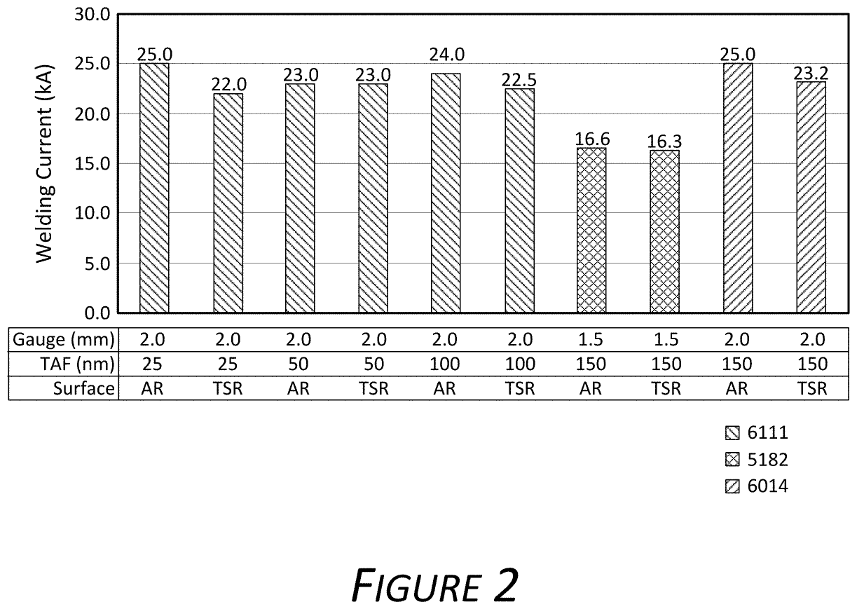

FIG. 2 is a graph showing the minimum current required for resistance spot welding (RSW) select exemplary alloys produced by methods described herein. Alloys AA6111, AA5182, and AA6014 were all formed and anodized according to methods described herein. Not to be bound by theory, during resistance spot welding, optimal parameters include a high surface resistance between the surfaces that are being welded (e.g., in contact with each other at a weld site) to generate resistive heating at the interface and form a weld. Additionally, a low surface resistance at an interface between a welding tip and the surface in contact with the welding tip (e.g., a welding tip interface) can further optimize RSW. Thus, the thin anodized film layer can be provided on a single side of the continuous coil, or removed from a side of the continuous coil (e.g., when all surfaces are anodized), to provide a welding tip interface side. In some cases, the thin anodized film layer is configured to allow the welding tip to penetrate the thin anodized film layer, or provide minimal resistance to allow current to freely flow from the welding tip to the surface. Accordingly, RSW can be optimized by a low resistance at the welding tip interface and high resistance at the weld site. For experimental purposes, the thin anodized film layer was removed from select samples before welding trials (referred to as “TSR” (top surface removed)) in FIG. 2. Samples with the thin anodized film layer intact during welding are referred to as “AR” (as received). Alloy samples with a thin anodized film layer (AR) required a higher welding current when compared to similar alloy samples having the thin anodized film layer removed, though only slightly higher for AA5182 alloy samples. Alloy samples welded with the thin anodized film layer removed (TSR) simulated penetrating the pretreatment thin anodized film during RSW, wherein the electrodes can be able to directly contact the aluminum alloy product bypassing the more resistive pretreatment thin anodized film layer. Resistance spot welds performed through the pretreatment thin anodized film layer required more current for successful welds.

### Example 2

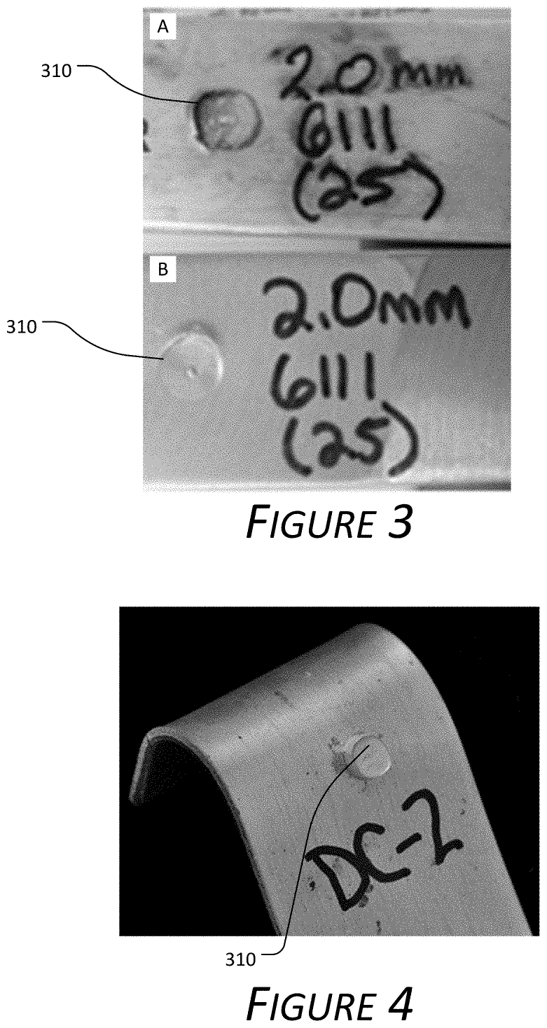

FIG. 3 shows digital images of aluminum alloy samples produced, anodized, and welded according to methods described herein. FIG. 3, panel A shows an AA6111 alloy of a 2 mm thick gauge having a 25 nm thick thin anodized film layer. FIG. 3, panel B shows an AA6111 alloy of a 2 mm thick gauge without a thin anodized film layer, as the 25 nm thick thin anodized film layer was removed prior to RSW. Removing the thin anodized film layer prior to welding simulated welding with the electrode penetrated through the thin anodized film layer. A RSW weld button 310 defines a spot where the weld occurred.

FIG. 4 is a digital image of an aluminum alloy sample produced, anodized, welded, and deformed according to methods described herein. The aluminum alloy sample was subjected to a button pull experiment. The button pull exhibited a successful weld.

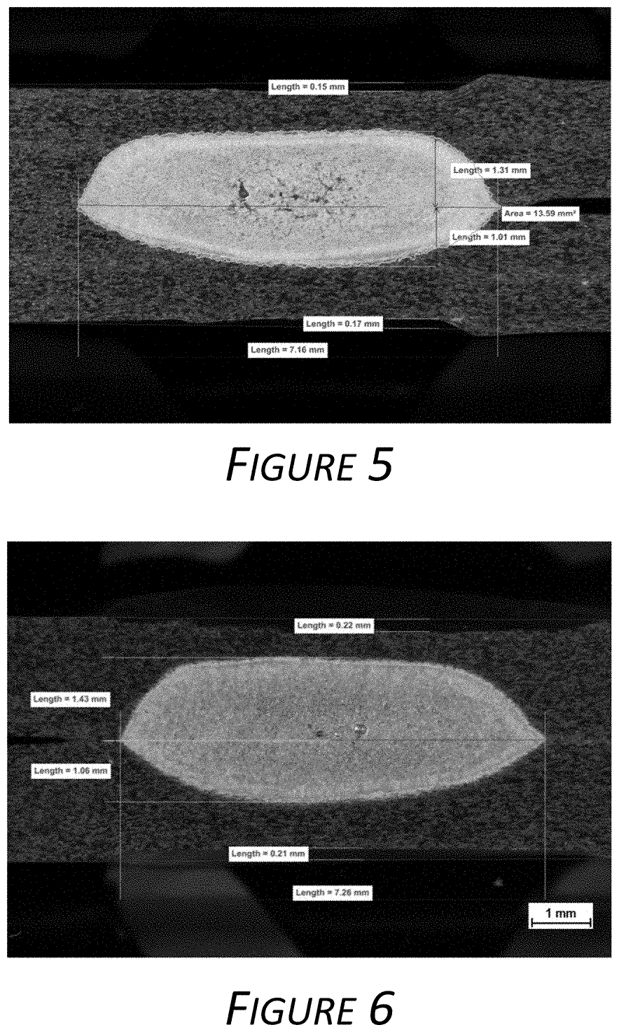

FIGS. 5 and 6 show cross-sectional micrographs of resistance spot welded aluminum alloy samples. The figures demonstrate that resistance spot welding (RSW) of the aluminum alloy samples was successful, indicating that the thin anodized film layer promoted adhesion without hindering joining by RSW.

### Example 3

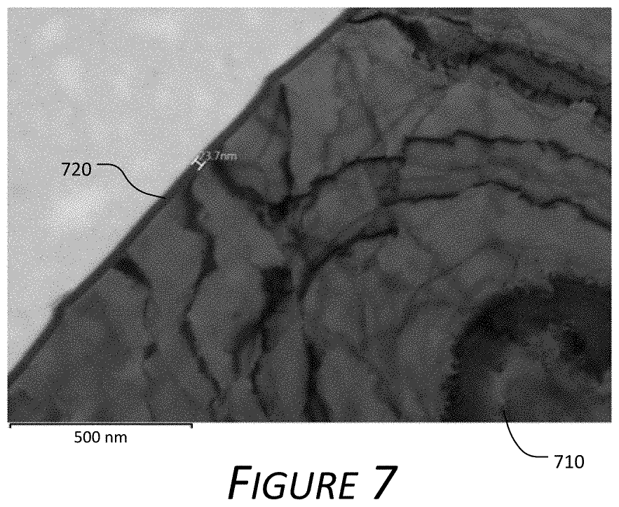

FIG. 7 is a cross-sectional micrograph of an aluminum alloy 710 having the thin anodized film layer 720. The thin anodized film layer 720 was formed on an aluminum alloy containing 99.99 wt. % Al and about 0.005 wt. % Cu. The electrolyte used for anodization was ammonium pentaborate and anodization was performed at an electrolyte temperature of 31° C. As shown in FIG. 7, the thin anodized film layer 720 conforms to the surface morphology of the aluminum alloy 710. Additionally, the thin anodized film layer 720 is devoid of defects and has a uniform thickness of about 24 nm as indicated on the micrograph.

All patents, publications, and abstracts cited above are incorporated herein by reference in their entireties. Various embodiments of the invention have been described in fulfillment of the various objectives of the invention. It should be recognized that these embodiments are merely illustrative of the principles of the present invention. Numerous modifications and adaptations thereof will be readily apparent to those skilled in the art without departing from the spirit and scope of the present invention as defined in the following claims.

What is claimed is:

1. An anodized continuous coil, comprising:
an aluminum alloy continuous coil, wherein a surface of the aluminum alloy continuous coil comprises a thin anodized film layer and a chemical additive layer.

2. The anodized continuous coil of claim 1, wherein the thin anodized film layer comprises a barrier layer.

3. The anodized continuous coil of claim 2, wherein the barrier layer is up to about 25 nm in thickness.

4. The anodized continuous coil of claim 1, wherein the thin anodized film layer is less than about 100 nm in thickness.

5. The anodized continuous coil of claim 1, wherein the chemical additive layer comprises an adhesion promoter, a coupling agent, a corrosion inhibitor, or a pretreatment, and wherein the chemical additive layer is up to about 50 nm in thickness.

6. An aluminum alloy product prepared from the anodized continuous coil of claim 1, wherein the aluminum alloy product comprises an electronic device substrate, an automobile body part, an aerospace structural part, a transportation body part, a transportation structural part, or an electronic device housing.

7. A method of making an anodized continuous coil, comprising:
providing a metal continuous coil, wherein the metal continuous coil is processed in a metal processing line having a preselected line speed;
etching a surface of an aluminum alloy continuous coil with an acidic solution;
anodizing the surface of the aluminum alloy continuous coil in an electrolyte to form a thin anodized film layer, wherein anodizing parameters are tailored to the preselected line speed of the metal processing line; and
applying a chemical additive to the thin anodized film layer to form a chemical additive layer.

8. The method of claim 7, wherein the thin anodized film layer comprises an aluminum oxide layer, and wherein the thin anodized film layer is less than about 100 nm in thickness.

9. The method of claim 7, wherein the chemical additive layer is up to about 50 nm in thickness, and wherein the chemical additive layer comprises an adhesion promoter, a coupling agent, a corrosion inhibitor, or a pretreatment.

10. The method of claim 7, further comprising applying a cleaner to the surface of the aluminum alloy continuous coil prior to the etching step, and further comprising rinsing the thin anodized film layer after the anodizing step.

11. An electronic device substrate, comprising:
an aluminum alloy continuous coil; and
a thin anodized film layer,
wherein the thin anodized film layer is configured to provide semiconductive properties to the aluminum alloy continuous coil, and
wherein the thin anodized film layer is positioned on an area of a surface of the aluminum alloy continuous coil.

12. The electronic device substrate of claim 11, wherein the thin anodized film layer comprises a uniform thickness across the area of the surface of the aluminum alloy continuous coil.

13. The electronic device substrate of claim 12, wherein the uniform thickness is configured to conform to a surface morphology of the aluminum alloy continuous coil.

14. The electronic device substrate of claim 12, wherein the uniform thickness across the area of the surface of the aluminum alloy continuous coil is devoid of pinholes and pin-spots.

15. The electronic device substrate of claim 11, wherein the thin anodized film layer comprises a uniform dielectric constant across the area of the surface of the aluminum alloy continuous coil.

16. The electronic device substrate of claim 11, wherein the thin anodized film layer comprises a breakdown voltage across the area of the surface of the aluminum alloy continuous coil, wherein the breakdown voltage comprises at least about 10 volts.

17. The electronic device substrate of claim 11, wherein the thin anodized film layer comprises a leakage current across the area of the surface of the aluminum alloy continuous coil, wherein the leakage current comprises up to about 100 nanoAmperes.

18. The electronic device substrate of claim 11, wherein the thin anodized film layer is stable up to a frequency of about 100 megaHertz.

19. The electronic device substrate of claim 11, wherein the aluminum alloy continuous coil comprises a conductive layer and the thin anodized film layer comprises a dielectric layer.

20. The electronic device substrate of claim 11, wherein the electronic device substrate is a substrate for an energy storage device, a substrate for an energy harvesting device, a substrate for an energy consuming device, or a substrate for a circuit component.
